(19) United States
(12) Patent Application Publication
(10) Pub. No.: US 2020/0402116 A1
(43) Pub. Date: Dec. 24, 2020

(54) SYSTEM, METHOD, COMPUTER PROGRAM PRODUCT OR PLATFORM FOR EFFICIENT REAL ESTATE VALUE ESTIMATION AND/OR OPTIMIZATION

(71) Applicant: Reali Inc., San Mateo, CA (US)

(72) Inventors: Ami Amiel Shai AVRAHAMI, Rehovot (IL); Mati COHEN, Ganei Tikva (IL); Idan FONEA, Kfar Saba (IL); Israel Jay KLEIN, Kfar Saba (IL)

(21) Appl. No.: 16/905,221

(22) Filed: Jun. 18, 2020

Related U.S. Application Data
(60) Provisional application No. 62/863,325, filed on Jun. 19, 2019.

(51) Int. Cl. G06Q 30/02; G06Q 50/16; G06K 9/00; G06N 3/08; G06N 3/04

(52) U.S. Cl. CPC G06Q 30/0278; G06Q 30/0283; G06N 3/049; G06K 9/00637; G06N 3/08; G06Q 50/16

(57) ABSTRACT

A computerized system for estimating real estate value, the system comprising: a user interface prompting human experts to generate at least one first estimate of at least one real estate item's value; and a processor configured to receive input characterizing the at least one real estate item aka asset (e.g. house), and, based at least partly on the input, to generate at least one second estimate of the at least one real estate item's value; and logic which combines the at least one first estimate and the at least one second estimate, thereby to yield an ensemble estimate of the at least one real estate item's value.

### REFERENCE TO CO-PENDING APPLICATIONS

Priority is claimed from U.S. Provisional Patent Application No. 62/863,325 “System, Method, Computer Program Product Or Platform For Value Estimation And/Or Optimization For Real Estate Properties” filed on 19 Jun. 2019, the disclosure of which application/s is hereby incorporated by reference.

### FIELD OF THIS DISCLOSURE

The present invention relates generally to software and more particularly to application software.

### BACKGROUND FOR THIS DISCLOSURE

Known technologies for estimating real estate prices are described for example, in: The Economic Value Of Neighborhoods www.researchgate.net/publication/326914228_The_Economic_Value_of_Neighborhoods_Predicting_Real_Estate_Prices_from_the_Urban_Environment

Estimation of the Investability of Real Estate Properties Through Text Analysis researchers.cdu.edu.au/en/publications/estimation-of-the-investability-of-real-estate-properties-through Vision-based_Real_Estate_Price_Estimation https://arxiv.org/abs/1707.05489 and in the following patent documents:

a. patents.google.com/patent/US6401070B1/en

b. patents.google.com/patent/US5361201A/en

c. patents.google.com/patent/US8195473

d. patents.google.com/patent/CN102254277A/en

e. www.freepatentsonline.com/y2018/0068329.html

f. patents.justia.com/patent/7822691

g. patents.justia.com/patent/7509261

A conventional comps report creation process is described here:
realeflow.kavako.com/article/241-comp-report-how-to-create.

The disclosures of all publications and patent documents mentioned in the specification, and of the publications and patent documents cited therein directly or indirectly, are hereby incorporated by reference other than subject matter disclaimers or disavowals. If the incorporated material is inconsistent with the express disclosure herein, the interpretation is that the express disclosure herein describes certain embodiments, whereas the incorporated material describes other embodiments. Definition/s within the incorporated material may be regarded as one possible definition for the term/s in question.

### SUMMARY OF CERTAIN EMBODIMENTS

Certain embodiments of the present invention seek to provide circuitry typically comprising at least one processor in communication with at least one memory, with instructions stored in such memory executed by the processor to provide functionalities which are described herein in detail. Any functionality described herein may be firmware-implemented or processor-implemented, as appropriate.

The following terms may be construed either in accordance with any definition thereof appearing in the prior art literature or in accordance with the specification, or to include in their respective scopes, the following:

ML=machine learning

NN=neural network

System-generated estimations of an unknown parameter or scalar may include the following:

EP may include an initial estimated price, an initial estimate of the property based on initial background data.

EP′ may include a modified estimated price as the initial estimate is modified due to additional data received at a later stage.

PC may include a price correction estimator.

LP may include a listing price, the advertised price of the property when released to the market for sale. Typically, LP=EP′+PC.

SP may include a sale price, the actual value paid by the buyer for the property; this may be stored in the system.

Delta, Δ may include a difference between e.g. the sale price and estimated price.

Ensemble Estimator or Combined Estimation may include an estimation method based on blending at least 2 assessment methods typically by a weighted addition of the estimations of each method.

Normalized Variable may include a given variable (e.g., normalized listed price) which is calibrated according to some adjustment process involving other features.

Value: e.g. real estate value is intended to include any of EP, EP′, PC, LP unless otherwise indicated.

According to certain embodiments, for each house to be sold, the system, using human inputs, performs all or any subset of the following operations, suitably ordered e.g. as follows:

Compute ep

Compute pc

Combine ep, pc e.g. by addition, to yield proposed sale price aka list price or asking price for house

An example flow which may be followed for each house put up for sale (aka “target house”) may include all or any subset of the following operations, suitably ordered e.g. as follows:

a. server generates comps report which yields an initial set of similar houses sold in the past

b. platform prompts human agent to reduce initial set

c. server computes house value (ep) by computing weighted average over all houses in reduced set, where weights=how long ago was sale, plus how similar is each house to house now up to sale

d. server computes correction to house value to yield asking price (aka list price) which reflects strategies etc.

Operation d may include all or any subset of the following operations, suitably ordered e.g. as follows:

D1. Define a certain selling/buying criterion

D2. Compute pc, to optimize that criterion

D3. Combine ep from operation c, with pc from operation d2, to yield list price

D4. Display list price

Any of the teachings herein may be used to implement any of the above operations.

According to certain embodiments, a system or platform is provided, which, at least once, functions not merely as a price prediction tool, but rather as a listing price optimization tool, e.g. by seeking a price for maximizing revenue for the seller (or minimizing loss for a buyer). The actual value of the home is not used as the list price and instead is further processed (e.g., PC/EP) to yield a list price which may for example, optimize certain selling (or buying) criteria.

Certain embodiments seek to provide a system or platform which uses a hardware processor to perform computations, wherein the computations including generating list prices for a target real estate item e.g. by combining prices at which similar real estate objects, typically selected from among a data repository of real estate objects known to the system, were sold, thereby to yield a first interim value, and/or correcting the first interim value to reflect difference/s between the target real estate item and the similar real estate objects and/or modifying the first interim value, e.g. as corrected, to obtain a listing price, typically using (either automatically or via an agent) data accumulated or accessed by the system and wherein at least one of the computations or “stages” described herein, such as EP computation stage, EP′ computation stage, PC computation stage etc., is performed by plural modules which may be activated or deactivated or modified e.g. improved (e.g. by machine learning using training data accumulated by the system/platform) through the lifetime of the product. For example, early in its lifetime, a platform may use, for a certain stage or for certain computations, 1-2 modules which don't require training, may then accumulate N e.g. thousands of records regarding respective real estate items, and may then add an NN based module trained using data thus accumulated which, e.g. together with other modules, can improve the outcome of that stage relative to the original 1-2 modules.

However alternatively, a simpler architecture which is not scalable or not upgradable, may be employed.

According to certain embodiments, a system or platform is provided which accumulates data regarding a set of potential buyers and data regarding a set of homes including whether each home was sold and at what price, and which of the home-seekers, aka potential buyers, interacted with (e.g. visited) each home, and wherein the system is configured to at least once select a subset of the set, the subset including only some of the homes which were sold, and to generate an estimate for a target home not yet sold, wherein generation of the estimate includes combining prices at which the homes in the subset, but not homes outside the subset, were sold, and wherein the subset is selected to include homes similar to the target home and wherein similarity is deduced at least partly by rating pairs of homes whose sets of visitors, from among the population of home-seekers/potential buyers, include more common members, as more similar, and rating pairs of homes whose sets of visitors, from among the population of home-seekers, include less common members, as less similar. The “sets of visitors” may alternatively be sets of potential buyers who made an offer for certain homes, or otherwise interacted with certain homes, rather than potential buyers who visited those homes.

It is appreciated that any reference herein to, or recitation of, an operation being performed is, e.g. if the operation is performed at least partly in software, intended to include both an embodiment where the operation is performed in its entirety by a server A, and also to include any type of “outsourcing” or “cloud” embodiments in which the operation, or portions thereof, is or are performed by a remote processor P (or several such), which may be deployed off-shore or “on a cloud”, and an output of the operation is then communicated to, e.g. over a suitable computer network, and used by, server A. Analogously, the remote processor P may not, itself, perform all of the operations, and, instead, the remote processor P itself may receive output/s of portion/s of the operation from yet another processor/s P, may be deployed off-shore relative to P, or “on a cloud”, and so forth.

There is thus provided, in accordance with at least one embodiment of the present invention,

The present invention typically includes at least the following embodiments:

Embodiment 1. A computerized system for estimating real estate value, the system comprising:

a user interface, generated by a hardware processor and configured for prompting human experts to generate at least one first estimate of at least one real estate item's value; and/or

a/the hardware processor configured to receive input characterizing the at least one real estate item aka asset (e.g. house), and, based at least partly on the input, to generate at least one second estimate of the at least one real estate item's value; and/or

logic which combines the at least one first estimate and the at least one second estimate, thereby to yield an ensemble estimate of the at least one real estate item's value.

Embodiment 2. A system according to claim 1 wherein an NN based similar listing finder is used which is configured to identify a similar listing to at least one real estate item using user-item engagement (“collaborative”) data for houses features and embedding plural house features into an N-dimensional space, the method including training a deep neural network according to houses previously chosen by end-users.

Embodiment 3. A system according to any of the preceding embodiments wherein convolutional NN is used to analyze house images including identification of the level of renovation of at least one room in the real estate item.

Embodiment 4. A system according to any of the preceding embodiments wherein the input includes house-style of the at least one real estate item (e.g. house) as derived from automatic analysis of digital house images.

Embodiment 5. A system according to any of the preceding embodiments wherein the input includes at least one real estate item feature derived from at least one of street view and satellite images of the at least one real estate item.

Embodiment 6. A system according to any of the preceding embodiments wherein the feature is derived from an AT process receiving at least one of the street view and the satellite images.

Embodiment 7. A system according to any of the preceding embodiments wherein the AI process comprises convolutional NN.

Embodiment 8. A system according to any of the preceding embodiments wherein the feature includes at least one of: view, house positioning, house layout.

Embodiment 9. A system according to any of the preceding embodiments wherein the input includes name entity recognition (NER) data derived or mined from text describing the asset which is read by the system.

Embodiment 10. A system according to any of the preceding embodiments wherein the name entity recognition (NER) data is derived by bidirectional LSTMs.

Embodiment 11. A system according to any of the preceding embodiments wherein at least one deep learning and/or neural network library, e.g. Keras, is used to implement at least one operation.

Embodiment 12. A system according to any of the preceding embodiments wherein Bidirectional LSTMs are provided using Keras's bidirectional layer wrapper.

Embodiment 13. A system according to any of the preceding embodiments wherein the processor generates the second estimate based also on heuristics which use pricing strategy data.

Embodiment 14. A system according to any of the preceding embodiments wherein the pricing strategy data includes a numerical level ranking urgency to sell the asset.

Embodiment 15. A system according to any of the preceding embodiments wherein the pricing strategy data includes an indication of high/low MOI.

Embodiment 16. A system according to any of the preceding embodiments wherein the heuristics include market-culture-data-dependent decisions re whether to overprice or underprice.

Embodiment 17. A system according to any of the preceding embodiments wherein the market-culture-data is estimated for each submarket using an SP/LP ratio plot, and wherein a ratio larger than one means an underpricing strategy, while a ratio smaller than one means an overpricing strategy.

Embodiment 18. A system according to any of the preceding embodiments wherein the logic is configured to combine the at least one first estimate and the at least one second estimate.

Embodiment 19. A system according to any of the preceding embodiments wherein a human agent provides at least one input toward value estimation of at least one real estate property, to the system, after having first been presented with at least partly computer-generated data characterizing the real estate property, and wherein the input provided to the system by the agent after having first been presented with the data, is subsequently used at least once by the system for estimation of value of the real estate property.

For example, the system may implement a “human-in-the-loop” algorithm which utilizes a real, human, “Real Estate Agent” to provide list price estimation e.g. by prompting the human agent to augment AI based list-price estimations.

Embodiment 20. A system comprising at least one hardware processor configured to carry out the operations of the method of any of the preceding embodiments.

Embodiment 21. A computer program product, comprising a non-transitory tangible computer readable medium having computer readable program code embodied therein, the computer readable program code adapted to be executed to implement the method of any of the preceding embodiments.

Embodiment 22. A system according to any of the preceding embodiments wherein all or any subset of the following are performed:

a. An estimated price based on a human agent is combined with an estimate based on an automatic process yielding a further estimated price.

b. Estimated price feeds an automatic process which predicts corrected or modified estimated price.

c. A human expert estimate is fed by the previous expert's estimate.

d. The price predicted by the automatic process is combined again with the human expert estimate

e. The modified estimated price feeds an automatic process predicting the list price, while the human expert estimate is fed by the previous expert's estimate.

f. a human agent supplies data without using automatically computed results.

Also provided, excluding signals, is a computer program comprising computer program code means for performing any of the methods shown and described herein when the program is run on at least one computer; and a computer program product, comprising a typically non-transitory computer-usable or -readable medium e.g. non-transitory computer-usable or -readable storage medium, typically tangible, having a computer readable program code embodied therein, the computer readable program code adapted to be executed to implement any or all of the methods shown and described herein. The operations in accordance with the teachings herein may be performed by at least one computer specially constructed for the desired purposes or general purpose computer specially configured for the desired purpose by at least one computer program stored in a typically non-transitory computer readable storage medium. The term “non-transitory” is used herein to exclude transitory, propagating signals or waves, but to otherwise include any volatile or non-volatile computer memory technology suitable to the application.

Any suitable processor/s, display and input means may be used to process, display e.g. on a computer screen or other computer output device, store, and accept information such as any data used by or generated by any of the methods and apparatus shown and described herein; the above processor/s, display and input means including computer programs, in accordance with all or any subset of the embodiments of the present invention. Any or all functionalities of the invention shown and described herein, such as but not limited to operations within flowcharts, may be performed by any one or more of: at least one conventional personal computer processor, workstation or other programmable device or computer or electronic computing device or processor, either general-purpose or specifically constructed, used for processing; a computer display screen and/or printer and/or speaker for displaying; machine-readable memory such as flash drives, optical disks, CDROMs, DVDs, BluRays, magnetic-optical discs or other discs; RAMs, ROMs, EPROMs, EEPROMs, magnetic or optical or other cards, for storing, and keyboard or mouse for accepting. Modules illustrated and described herein may include any one or combination or plurality of: a server, a data processor, a memory/computer storage, a communication interface (wireless (e.g. BLE) or wired (e.g. USB)), and a computer program stored in memory/computer storage.

The term “process” as used above is intended to include any type of computation or manipulation or transformation of data represented as physical, e.g. electronic, phenomena which may occur or reside e.g. within registers and/or memories of at least one computer or processor. Use of nouns in singular form is not intended to be limiting; thus the term processor is intended to include a plurality of processing units which may be distributed or remote, the term server is intended to include plural typically interconnected modules running on plural respective servers, and so forth.

The above devices may communicate via any conventional wired or wireless digital communication means, e.g. via a wired or cellular telephone network or a computer network such as the Internet.

The apparatus of the present invention may include, according to certain embodiments of the invention, machine readable memory containing or otherwise storing a program of instructions which, when executed by the machine, implements all or any subset of the apparatus, methods, features and functionalities of the invention shown and described herein. Alternatively or in addition, the apparatus of the present invention may include, according to certain embodiments of the invention, a program as above which may be written in any conventional programming language, and optionally a machine for executing the program such as but not limited to a general purpose computer which may optionally be configured or activated in accordance with the teachings of the present invention. Any of the teachings incorporated herein may, wherever suitable, operate on signals representative of physical objects or substances.

The embodiments referred to above, and other embodiments, are described in detail in the next section.

Any trademark occurring in the text or drawings is the property of its owner and occurs herein merely to explain or illustrate one example of how an embodiment of the invention may be implemented.

Unless stated otherwise, terms such as, “processing”, “computing”, “estimating”, “selecting”, “ranking”, “grading”, “calculating”, “determining”, “generating”, “reassessing”, “classifying”, “generating”, “producing”, “stereo-matching”, “registering”, “detecting”, “associating”, “superimposing”, “obtaining”, “providing”, “accessing”, “setting” or the like, refer to the action and/or processes of at least one computer/s or computing system/s, or processor/s or similar electronic computing device/s or circuitry, that manipulate and/or transform data which may be represented as physical, such as electronic, quantities e.g. within the computing system's registers and/or memories, and/or may be provided on-the-fly, into other data which may be similarly represented as physical quantities within the computing system's memories, registers or other such information storage, transmission or display devices, or may be provided to external factors e.g. via a suitable data network. The term “computer” should be broadly construed to cover any kind of electronic device with data processing capabilities, including, by way of non-limiting example, personal computers, servers, embedded cores, computing system, communication devices, processors (e.g. digital signal processors (DSPs), microcontrollers, field programmable gate arrays (FPGAs), application specific integrated circuits (ASICs), etc.) and other electronic computing devices. Any reference to a computer, controller or processor is intended to include one or more hardware devices e.g. chips, which may be co-located or remote from one another. Any controller or processor may for example comprise at least one CPU, DSP, FPGA or ASIC, suitably configured in accordance with the logic and functionalities described herein.

Any feature or logic or functionality described herein may be implemented by processor/s or controller/s configured as per the described feature or logic or functionality, even if the processor/s or controller/s are not specifically illustrated for simplicity. The controller or processor may be implemented in hardware, e.g., using one or more Application-Specific Integrated Circuits (ASICs) or Field-Programmable Gate Arrays (FPGAs) or may comprise a microprocessor that runs suitable software, or a combination of hardware and software elements.

The present invention may be described, merely for clarity, in terms of terminology specific to, or references to, particular programming languages, operating systems, browsers, system versions, individual products, protocols and the like. It will be appreciated that this terminology or such reference/s is intended to convey general principles of operation clearly and briefly, by way of example, and is not intended to limit the scope of the invention solely to a particular programming language, operating system, browser, system version, or individual product or protocol. Nonetheless, the disclosure of the standard or other professional literature defining the programming language, operating system, browser, system version, or individual product or protocol in question, is incorporated by reference herein in its entirety.

Elements separately listed herein need not be distinct components and alternatively may be the same structure. A statement that an element or feature may exist is intended to include (a) embodiments in which the element or feature exists; (b) embodiments in which the element or feature does not exist; and (c) embodiments in which the element or feature exist selectably e.g. a user may configure or select whether the element or feature does or does not exist.

Any suitable input device, such as but not limited to a sensor, may be used to generate or otherwise provide information e.g. data received by the apparatus and methods shown and described herein. Any suitable output device or display may be used to display or output information generated by the apparatus and methods shown and described herein. Any suitable processor/s may be employed to compute or generate information as described herein and/or to perform functionalities described herein and/or to implement any engine, interface or other system illustrated or described herein. Any suitable computerized data storage e.g. computer memory may be used to store information received by or generated by the systems shown and described herein. Functionalities shown and described herein may be divided between a server computer and a plurality of client computers. These or any other computerized components shown and described herein may communicate between themselves via a suitable computer network.

The system shown and described herein may include user interface/s e.g. as described herein, which may, for example, include all or any subset of: an interactive voice response interface, automated response tool, speech-to-text transcription system, automated digital or electronic interface having interactive visual components, web portal, visual interface loaded as web page/s or screen/s from server/s via communication network/s to a web browser or other application downloaded onto a user's device, automated speech-to-text conversion tool, including a front-end interface portion thereof and back-end logic interacting therewith. Thus the term user interface or “UI” as used herein includes also the underlying logic which controls the data presented to the user e.g. by the system display and receives and processes and/or provides to other modules herein, data entered by a user e.g. using her or his workstation/device.

### BRIEF DESCRIPTION OF THE DRAWINGS

Example embodiments are illustrated in the various drawings. Specifically:

FIGS. 1a-d, 2a-c, 6-7 are simplified block diagram illustrations of embodiments of the present invention; all or any subset of illustrated blocks may be provided;

FIGS. 3a-3b, 4-5 are example simplified screenshots which the system herein may generate according to certain embodiments;

FIG. 8 is a graph useful in understanding embodiments of the present invention;

FIGS. 9a-9b taken together form a table useful in understanding embodiments of the present invention.

Certain embodiments of the present invention are illustrated in the following drawings; in the block diagrams, arrows between modules may be implemented as APIs and any suitable technology may be used for interconnecting functional components or modules illustrated herein in a suitable sequence or order e.g. via a suitable API/Interface. For example, state of the art tools may be employed, such as but not limited to Apache Thrift and Avro which provide remote call support. Or, a standard communication protocol may be employed, such as but not limited to HTTP or MQTT, and may be combined with a standard data format, such as but not limited to JSON or XML.

Methods and systems included in the scope of the present invention may include any subset or all of the functional blocks shown in the specifically illustrated implementations by way of example, in any suitable order e.g. as shown. Flows may include all or any subset of the illustrated operations, suitably ordered e.g. as shown. Tables herein may include all or any subset of the fields and/or records and/or cells and/or rows and/or columns described.

Computational, functional or logical components described and illustrated herein can be implemented in various forms, for example, as hardware circuits such as but not limited to custom VLSI circuits or gate arrays or programmable hardware devices such as but not limited to FPGAs, or as software program code stored on at least one tangible or intangible computer readable medium and executable by at least one processor, or any suitable combination thereof. A specific functional component may be formed by one particular sequence of software code, or by a plurality of such, which collectively act or behave or act as described herein with reference to the fmctional component in question. For example, the component may be distributed over several code sequences such as but not limited to objects, procedures, functions, routines and programs, and may originate from several computer files which typically operate synergistically.

Each functionality or method herein may be implemented in software (e.g. for execution on suitable processing hardware such as a microprocessor or digital signal processor), firmware, hardware (using any conventional hardware technology such as Integrated Circuit technology) or any combination thereof.

Functionality or operations stipulated as being software-implemented may alternatively be wholly or fully implemented by an equivalent hardware or firmware module and vice-versa. Firmware implementing functionality described herein, if provided, may be held in any suitable memory device and a suitable processing unit (aka processor) may be configured for executing firmware code. Alternatively, certain embodiments described herein may be implemented partly or exclusively in hardware, in which case all or any subset of the variables, parameters, and computations described herein may be in hardware.

Any module or functionality described herein may comprise a suitably configured hardware component or circuitry. Alternatively or in addition, modules or functionality described herein may be performed by a general purpose computer, or more generally by a suitable microprocessor, configured in accordance with methods shown and described herein, or any suitable subset, in any suitable order, of the operations included in such methods, or in accordance with methods known in the art.

Any logical functionality described herein may be implemented as a real time application, if and as appropriate, and which may employ any suitable architectural option, such as but not limited to FPGA, ASIC or DSP or any suitable combination thereof.

Any hardware component mentioned herein may in fact include either one or more hardware devices e.g. chips, which may be co-located or remote from one another.

Any method described herein is intended to include, within the scope of the embodiments of the present invention, also any software or computer program performing all or any subset of the method's operations, including a mobile application, platform or operating system e.g. as stored in a medium, as well as combining the computer program with a hardware device to perform all or any subset of the operations of the method.

Data can be stored on one or more tangible or intangible computer readable media stored at one or more different locations, different network nodes or different storage devices at a single node or location.

It is appreciated that any computer data storage technology, including any type of storage or memory and any type of computer components and recording media that retain digital data used for computing for an interval of time, and any type of information retention technology, may be used to store the various data provided and employed herein. Suitable computer data storage or information retention apparatus may include apparatus which is primary, secondary, tertiary or off-line; which is of any type or level or amount or category of volatility, differentiation, mutability, accessibility, addressability, capacity, performance and energy use; and which is based on any suitable technologies such as semiconductor, magnetic, optical, paper and others.

### DETAILED DESCRIPTION OF CERTAIN EMBODIMENTS

A common need when selling and buying real estate properties as houses, is efficiently estimating home values e.g. by providing software to facilitate this. The estimation, and, in addition, the ability to provide an end-user with the reasoning behind the estimates, may be used for different applications.

For example, it is common in many countries that a house seller may hire an agent which may handle the selling process, and initially the agent may determine the so-called correct price for the house. While doing so, the agent is required by local regulations to compile evidence which will support the estimate. The evidence could be the prices of similar houses listed in the nearby vicinity or directly related to specific characteristics of the house (e.g., swimming pool, lot area, etc.).

In most cases, the determined estimate, listed price, or the actual final sale price, are quite different. There are many explanations for this dissimilarity—it may be related to macro or micro level economics which may influence the current housing markets, and it may be related to human behavior characteristics which influence the buy-sell pricing strategy. In other words, focusing only on an accurate estimation of the property's value (e.g., for initial advertisement purposes) may not yield the maximum potential sale price of the property.

When taking, for example, two identical houses, located in similar neighborhoods (identical in other social and geographical patterns) and both are listed for sale at the same time. They are both valued at 530,000 USD each. The first house is listed when entering the market at 540,000 USD, and after a couple of weeks is sold for 580,000 USD due to various market conditions. The second house is listed in parallel, but its seller advertises at a much higher listing price, 600,000 USD. As a result, this listing price attracts less potential buyers, and there are only a few number of bids. The second seller experiences an increased time-to-sell and may reduce the sale price, or take the house off the market for a while.

Certain embodiments relate to predictive modeling methods, thus more particularly augmenting the decision-making process of human experts in the real estate knowledge domain. The method according to certain embodiments is a combination of a manual and automated real estate processes. The manual processes involve human real estate experts. The automated process generates estimates based on learned relationships between features describing individual assets, as well as general house area characteristics. Furthermore, this method may be used to generate real estate reports on price trends and property specific recommendations.

The invention includes inter alia the following embodiments:

The optimization objective is to maximize the house sale potential defined as the Delta, which is the difference Delta=SP−EP (or alternatively, a ratio may be used) between the initial estimated price (EP) of the house and the final sale price (SP)

For any given asset at a given time, there is typically an optimal listing price (LP) (e.g. the advertised price when the property enters the market) which is presented when the asset is put on the marketplace, which typically maximize the delta.?

In some cases, the system may use the modified estimated price (EP′) as the baseline for maximization. In these cases, the original derived (or initial) estimated price is corrected based on additional information on (e.g. data descriptive of) the property at a later stage.

FIG. 6 describes home values that may be generated, in stages, e.g. using the operations shown.

In certain embodiments of the invention the optimal listing price is predicted by two sets of two methods. Manual and automated price estimations and/or two different methods may be used to estimate the LP. This combination may be used to yield an ensemble LP estimator (see definitions). Two exemplary variants are described below.

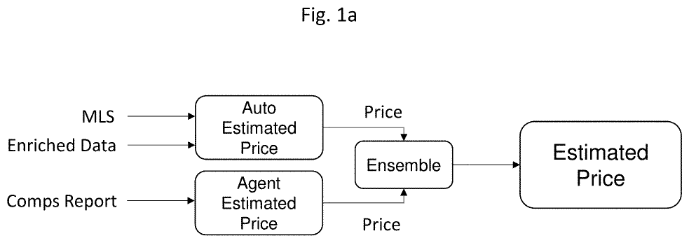

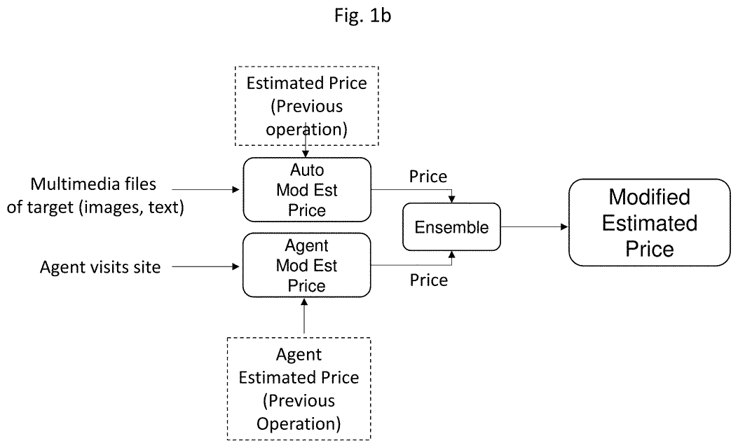

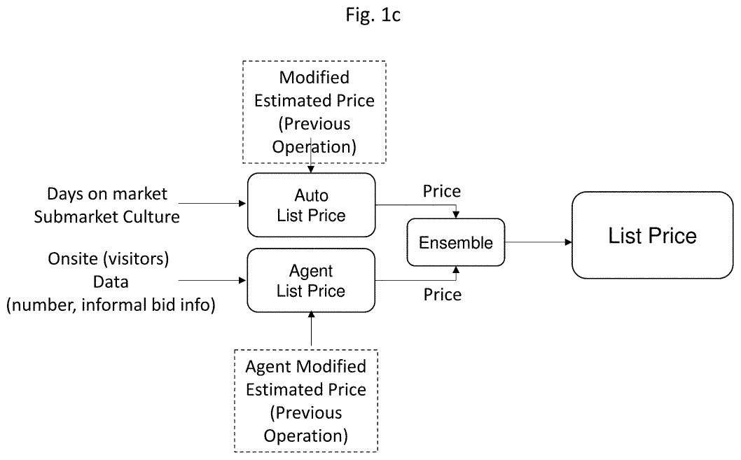

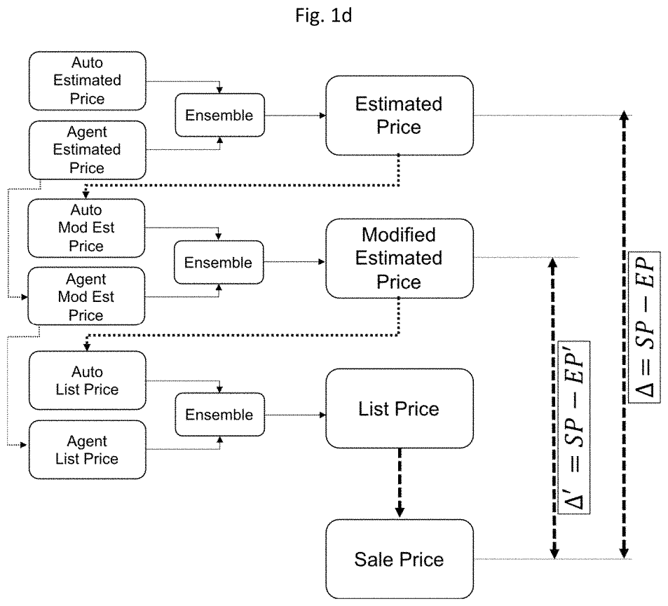

In one case, e.g. in FIG. 1d, all or any subset of the following may be performed:

1. An estimated price based on a human expert (e.g., real estate agent) is combined with an estimate based on some automatic process based on mathematics, statistics and machine learning or deep learning methods. The end result is a further estimated price.

2. Estimated price feeds an automatic process which predicts the corrected or modified estimated price.

3. A human expert estimate h′ is fed by the previous expert's estimate.

4. The price predicted by the above automatic process is combined again with the above human expert estimate h′

5. The modified estimated price feeds an automatic process predicting the list price aka listing price, while the human expert estimate is fed by the previous expert's estimate. The list price is used for introducing the property to the market and is computed with the purpose of maximizing the profit.

6. After some period, the property is sold at some sale price aka selling price and the differences (the deltas) between the sale price and (a) the initial estimated and/or (b) the modified estimated prices are recorded for future model training.

In contrast, in FIG. 7, the human expert estimates are based on the combined estimates. Thus in FIG. 7, the agent typically uses the ensemble or combination of the previous stage. Typically, then, the agent's functioning e.g. as a human, is augmented by the computerized product of a previous, interim stage. For example, the combined estimated price (hence the ensemble estimated price) is used to feed both the automatic process of modifying the estimated price, and the expert agent estimate as well.

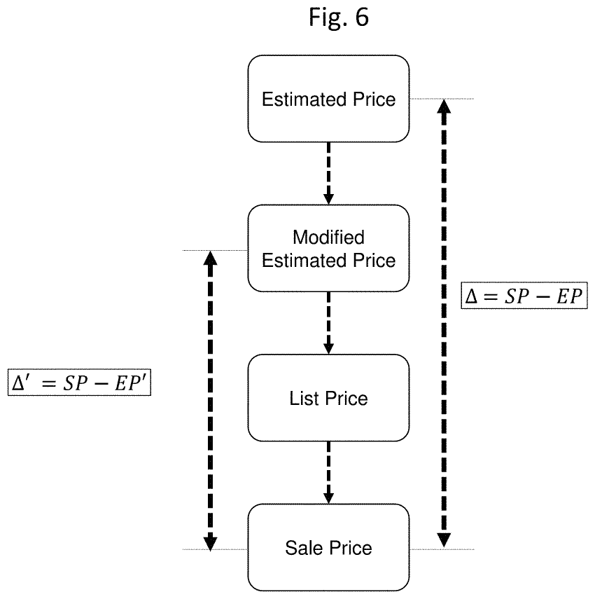

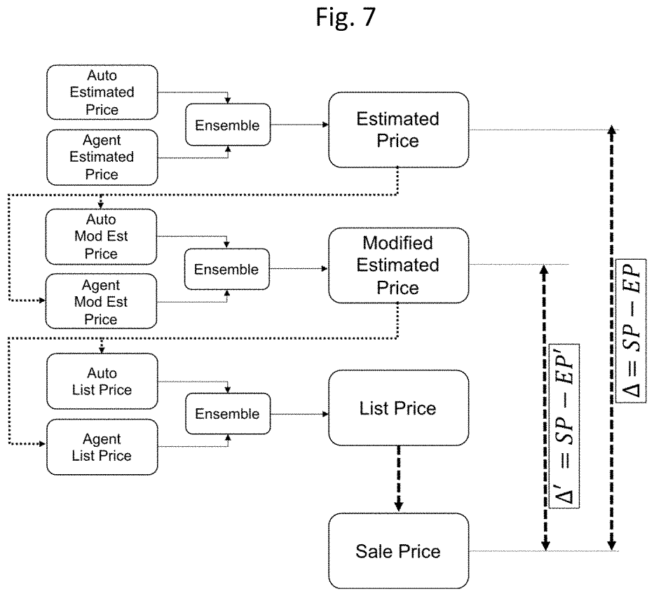

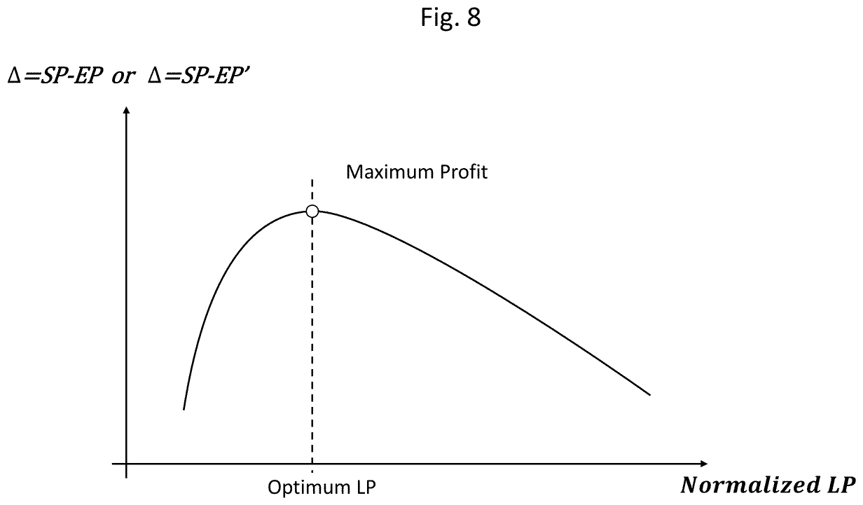

The model for predicting the optimum list price may use past listing price data against the delta to infer (e.g. as described below) the maximum value. In some embodiments, the list price may be normalized by property parameters such as the house size or number of rooms. In this example, normalization may be achieved by dividing the house price either to the house area (hence computing the price per sq. ft.) or to the number of rooms. Each house in a given area may go through the normalization process, and for each house the actual delta may be retrieved. A typical graph of delta vs. the normalized list price is shown in FIG. 8. The maximum point as obtained from the graph is considered to be the optimal normalized listing price (selected based on the past sales) (e.g., inferred by generating the EP of past sales). The normalized value is then translated back to the appropriate non-normalized value based on the same property values which normalized these values as before. For example, if normalization was achieved by the dividing the house price by its area, then in this case the normalized optimal list price is multiplied by the house area, resulting in the actual optimal list price.

The manual EP may be based on a manual Comps Report. A human expert estimates the price of the property based on online available data and images, and, using online tools as map sites (e.g., Google maps) while taking into consideration sub markets, house type and size and the sale date. The expert chooses several similar listing candidates for further consideration. In order to choose a small number (2-3) of most similar house sales to the target house, the expert may consider several corrections in order to normalize the different assets in the short list. The sale prices of the final assets chosen are the base for the EP. An average or the range of the normalized prices may be presented.

For the automated EP, the system may use a house database based on a combination of several publicly available datasets, taking into consideration a myriad of house features, such as sale date, sub market and house geometry etc. For example, there are various MLS (Multiple Listing Service) websites such as go.crms.org which store and manage listings of various houses in California, including property parameters and buy-sell related data. The method selects best similar listings for the EP. The method may also correct and normalize the sale price for cases where the selected houses are different in certain features which may be key in the sense of potentially affecting home value (e.g. pool, fireplace etc.) e.g. by compiling value data regarding similar houses with/without a pool (or fireplace), and determining an average ratio between a house with and without a pool/fireplace, then applying this ratio to normalize house values. The normalization is done in a submarket specific manner, as different submarkets may correct key features differently.

An additional aspect of the automated EP may be the use of a NN based similar listing finder. The system may select a similar listing using a user-item engagement (“collaborative”) data for houses features. The system may embed different house features into some N-dimensional space. Deep neural network is trained according to houses chosen by different users. This method allows to automatically choose similar listing in a buyer perspective manner.

For generating the EP′ manually, the experts are typically required to visit the property site. The expert may correct the EP according to visual inspection of the property and property area.

The automated EP′ may be based on the combination of all or any subset of the following three processes:
Room Image recognition
   The system may employ AI technologies for this purpose. For example, the system may use neural network to analyze house images including identification of the level of renovation of key rooms (in the sense of being rooms which affect home value more than other rooms) in a house sale transaction, e.g. bathrooms and/or kitchen. The process may also recognize the style of the house and/or general conditions that factored in the modification of EP to EP′. For example, using existing photos of different properties which are either recently renovated or not, and are tagged accordingly (labeled as renovated or not) by human experts; then, a neural network may be trained to classify the renovation status. The trained neural network may be applied for new photos of newly introduced properties, and evaluate them as required.
Outdoor Image recognition
   The system may employ street view and satellite images as an input to an AI process such as a neural network, to infer certain features of the house area (e.g., view house positioning, house layout etc.) which are typically factors in estimating EP′. For example, the system may determine that certain objects installed on the roof and visible (from above or from a street view angle) relate to certain features of the property. For example, certain ventilation arrangements may be indicative of the number of bathrooms. The system may apply a two-step process for training a neural network. First, the system may use image recognition methods for discovering those objects of interest. Secondly, the system may train the neural network by associating the what was visible (e.g., the number of ventilation pipes) with actual property features (e.g., total built area, number of rooms).
Name entity recognition (text mining)
   The system may employ for example bidirectional LSTMs for name entity recognition (NER) of the text describing the asset. Using this tool, the system may be able to infer feature/s of the specific asset e.g. fireplace, pool. This data may be used as well for estimating the EP′.

Regarding the manual settings of the list price—after setting EP′, an LP is generated by an expert which is well informed in the dynamics of house sales in the specific area. According to several considerations, such as the seller's background, the house market, and the sale strategies are customized for the specific submarket (e.g. overprice or underprice the assets for Delta maximization).

For the automated process for setting the LP Automated LP, the system may consider a price correction estimator, PC to modify EP′ to maximize Delta.

LP=EP′+PC

Hence after the EP′ is set, it may be modified according to the seller's data and market data.

PC estimation typically incorporates all or any subset of the following information:
Seller data—Data related to the seller, such as as age, income, urgency level etc. may be key components in the sale strategy
Market status—This may be defined by month on inventory, MOI:

MOI=e.g. Number of Listed Assets per Month/Number of Sales per Month
A low MOI means a “hot market” or a seller's market, while a high MOI means a “cold market” or buyer market.
Market culture—The best strategy may be dependent on the submarket. One submarket may overprice, that is a positive PC in a hot market and avoiding loss or attempting to anchor the house price, while another submarket might underprice to generate a bid war. The market culture may be estimated for each submarket using an SP/LP ratio plot. A ratio larger than one means an underpricing strategy, while a ratio smaller than one means an overpricing strategy.

A regression model may be used to estimate the contribution of each PC component based on historic real estate data.

A user interface may be provided for human expert end users, and/or a user interface may be provided for end-users who seek to receive system-generated real estate valuations, as described herein.

According to certain embodiments, a platform (e.g. according to the embodiments of FIG. 1d or 6-8) is provided which accumulates price estimation data (no matter what the actual method or system is for providing or computing or accumulating that data). This platform may, for example, be integrated with a bidding platform allowing buyer end-users to send bids to seller end-users regarding, say, properties offered by the seller end-users to the population of buyer end-users, and allowing the seller end-users to respond e.g. by accepting or rejecting each bid. Or, the platform may include only a bidding platform without price estimate accumulation functionality.

Such a platform may then be used to support a buyer end-user who seeks to make a bid e.g. on a property, while factoring into the price proposed in his bid, its or his subjective bias concerning a probability of his or its bid succeeding e.g. being accepted by a seller, to buy the property. It is appreciated that even assuming that a price estimation which is correct has been established, this still does not guarantee that an offer or bid based on this estimation may actually be the winning bid or may be accepted by the seller.

Increasing the offer may increase the winning chances of a given bid, whereas decreasing the offer may decrease the winning chances. A buyer may bias his or its bid or offer according to subjective reasoning (e.g., luck) or any a priori information known to the buyer (e.g., seller under pressure).

One embodiment of the invention provides a “human-in-the-loop” algorithm or system which utilizes a real, human, “Real Estate Agent” to augment AI based list-price estimations. The system may have both software functionality and an agent who may participate in the final list price estimation.

The human established price prediction is typically based on agent (e.g. human) domain knowledge which, by definition, is an unformulated estimation methodology of house pricing.

The software algorithms may employ image processing and/or text processing for (say) hedonic price estimation e.g. identifying and utilizing the various aspects which influence the list price. Hedonic regression may be used as a revealed preference method configured for estimating the demand for certain goods or services. This process typically breaks down the price estimation into its constituent characteristics, and obtains estimates of the contributory value of each characteristic.

Another embodiment of the invention provides, rather than a price prediction tool per se, a listing price optimization tool, configured for seeking the price for maximizing the revenue for the seller (or rather minimizing the loss for a buyer). This is advantageous relative to the prior art because conventional estimating of the price is not in fact the “right” price for selling the house—but rather only an initial operation yielding a baseline figure to be corrected (e.g., PC/EP) for optimizing some selling (or buying) criteria.

According to certain embodiments, a first operation is the derivation of the estimated price (FIG. 1a). This operation and all operations described hereinbelow may include a combination (or ensemble) of an automated process (which leads to an initial estimate) with a human based estimate. Input types described herein are only examples.

The automated process may use data received from MLS (e.g., number of rooms, house area, etc.) and enriched data sources (e.g., average income level of residents within the neighborhood). The agent may estimate the price based on his comps-report. Both estimates are combined (e.g., average, weighted average, etc.) into one estimate, an EP.

In FIG. 1b, the modified estimated price is computed. The automated estimate process may utilize the previous estimate, EP and/or may process the relevant multimedia files of the house as images. The agent modified estimate may use the agent's previous estimate (not modified) and may take into account an actual visit or survey of the house. The agent's own impression of the asset thus may be weighted into the estimate. As with the previous operation, the automated estimate and the agent's estimate may be combined, e.g. using a simple or weighted average, into a modified estimate price, EP′.

In FIG. 1c, the list price is estimated. The system may estimate the price correction (PC) and may offset the modified estimated price accordingly for computing the list price (LP=EP′+PC).

The automated estimate may, for example, use market data as the number of days the asset was on the market, and/or indices indicative of the market culture (e.g., financial market situation, average days on market of other assets etc.). The agent may receive onsite information regarding the number of customer visits, or if some informal bidding or inquiries took place during the visit. As with the previous operations, the final estimation may be based on combining, logically or computationally, both estimates. For example, the lower of the 2 estimates may be used. Or, under certain circumstances (“if”), the lower estimate may be used, whereas under other circumstances, the two combinations may be averaged simply, whereas under other circumstances, a weighted rather than simple combination of the two estimates is computed.

In FIG. 1d, the system may combine all three operations into one process which describes the complete flow end to end. Some of the inputs mentioned in FIGS. 1a, 1b and 1c are not shown, for simplicity.

GUI/UX functionality may be enabled, according to certain embodiments.

It may be desirable to facilitate the involvement of the human real estate agent through the optimization process; a possible implementation of a GUI/UX is described, supporting a comps report creation process.

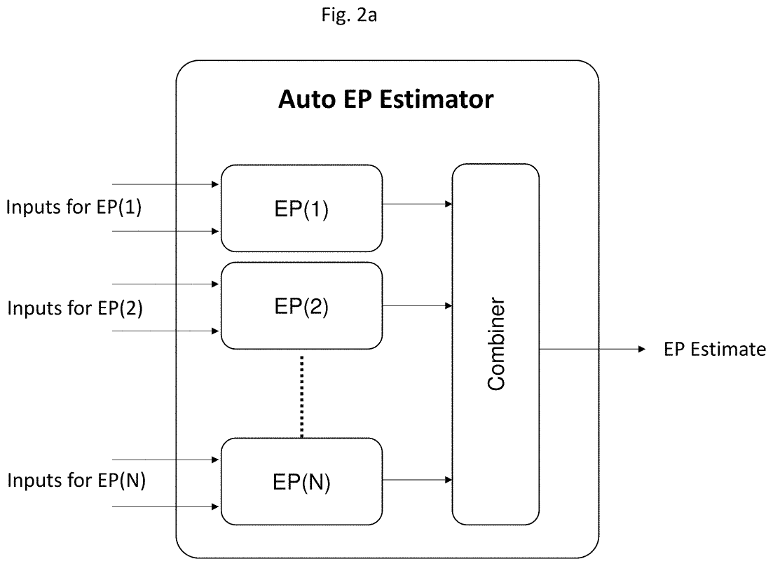

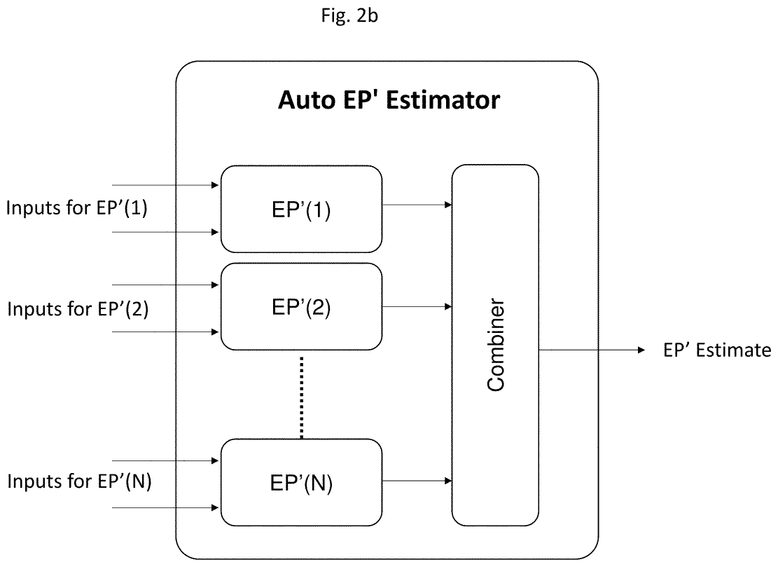

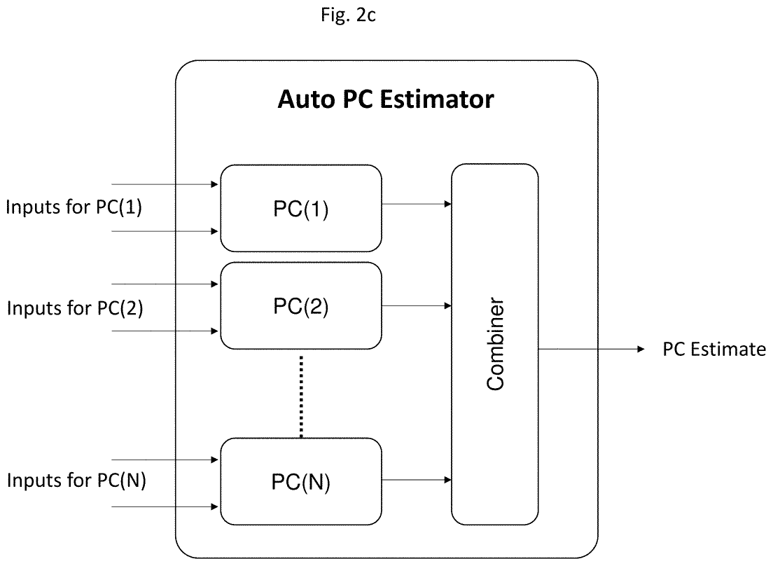

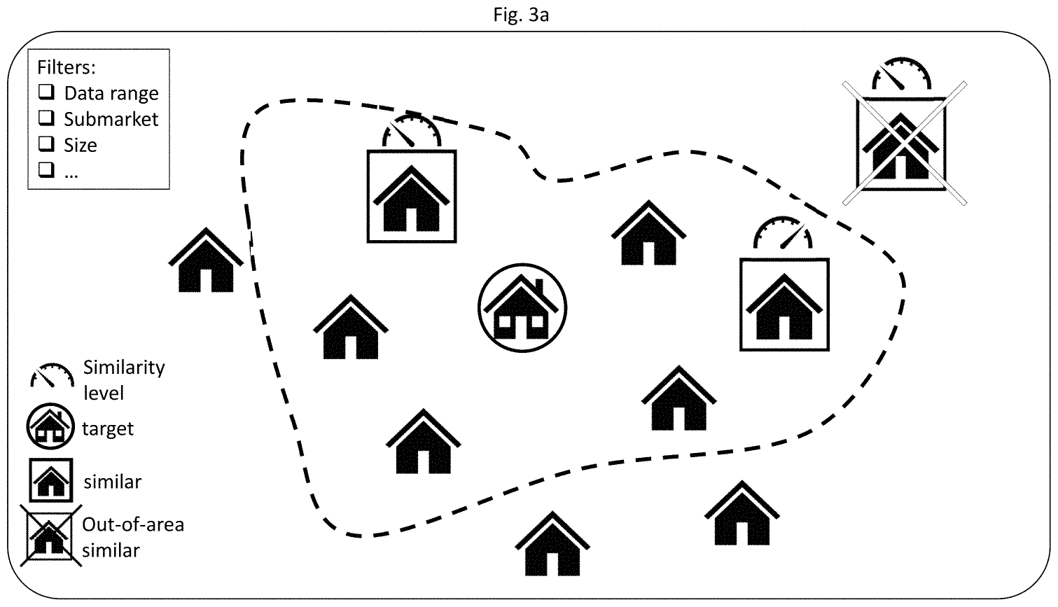

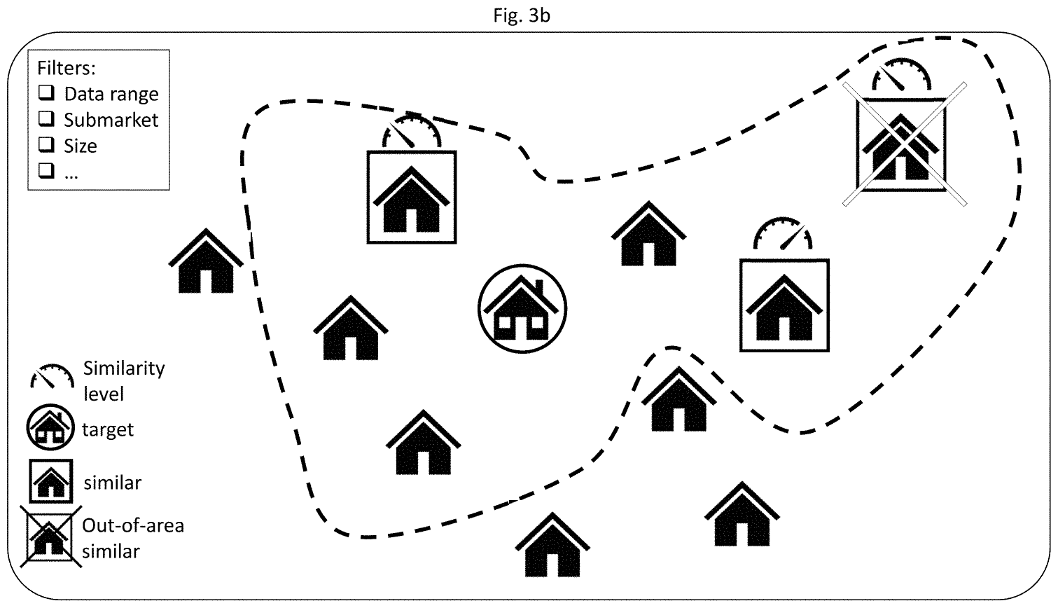

A 1^{st} screen display is shown in FIGS. 3a & 3b; all or any subset of the illustrated elements, here and in other screen displays herein, may be generated by the system of the present invention.

All similar houses (candidates by some a priori baseline) may be marked on a map which is presented to the agent which selects some of them (FIG. 3a).

The screen may include some information reflecting a similarity score (e.g. how similar the house is to the target house) and this may be presented using any suitable scheme (e.g., color coded, score meter, etc.).

The agent's selection process may be used to fine-tune the similarity and submarket designations. For example, (FIG. 3b) if specific houses within the submarket area are continuously avoided then the submarket region may be eventually modified to exclude these houses from this submarket (and vice versa).

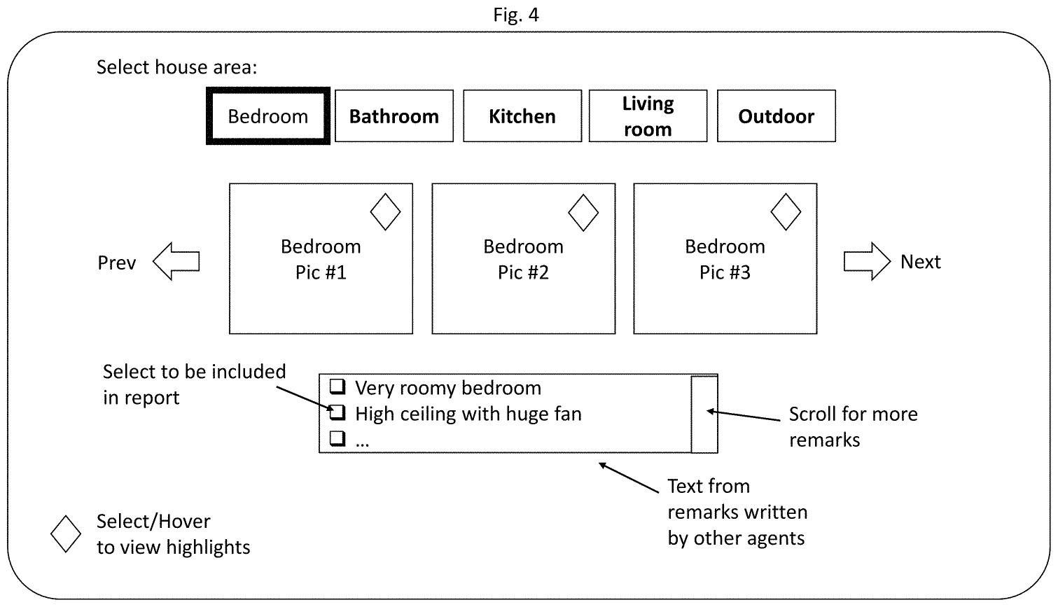

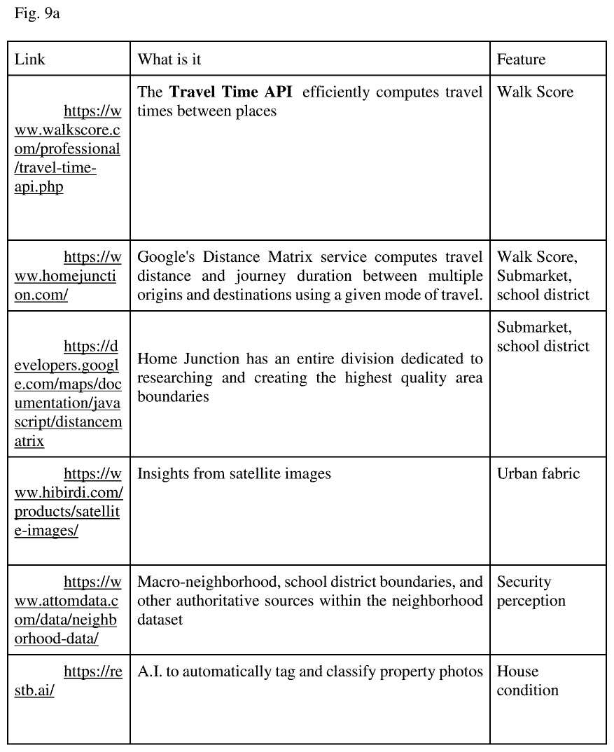

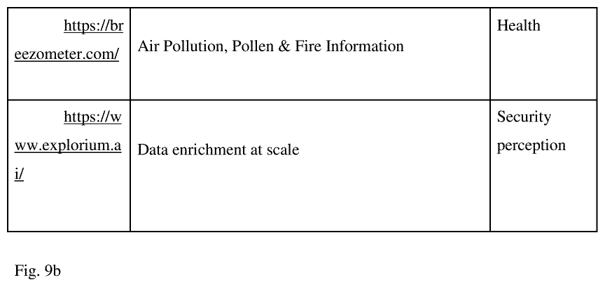

Referring now to FIG. 4 aka the 2^{nd} Screen: To facilitate correction of the comparison process, off-the-shelf tools like restb.ai (see table of FIGS. 9a-9b) may be used. As seen in FIG. 4, different images of the room may be presented in different tabs, sorted by, for example, room type. Specific features may be highlighted on the image itself for assisting the agent to retrieve information deemed important. Relevant agent remarks (for the specific rooms) using NER may be sorted and formatted as well for easier agent report construction.

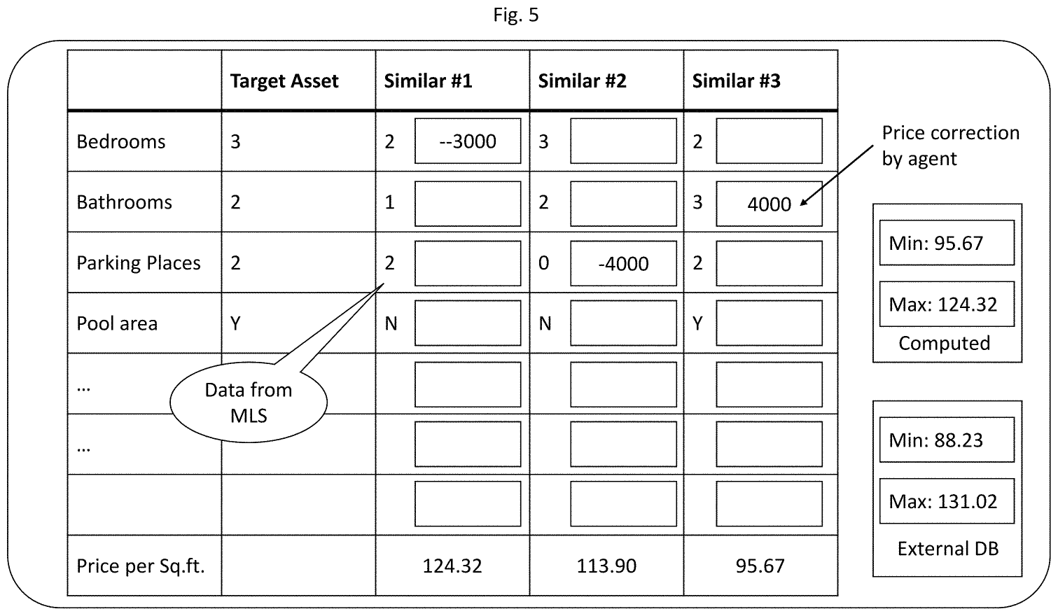

3^{rd} Screen: In FIG. 5, the agent is presented with a list (or table) of features and a suggested price difference factor for each (e.g., extra bathroom, pool existence, etc.). Typically, the data for each similar house is populated using MLSs. The agent may emphasize/de-emphasize these factors and these may be eventually used for future estimations. These factors are typically submarket dependent (e.g., a swimming pool may be of a lesser value in certain neighborhoods).

A price estimation interval is typically the final outcome of the comparison report. The screen may include supplemented data from other price estimation websites for comparative analysis (e.g. “External DB” in FIG. 5 represents some external, website database).

GUI/UX functionality may be enabled by the invention, e.g. as described above, as it is may be useful to facilitate the involvement of the human real estate agent through the optimization process. the screenshots herein represent only one possible implementation of a GUI/UX that may be generated, for supporting a comps report creation process. This may be useful to facilitate EP computation, e.g. with human involvement.

The comps report typically comprises a comparison report between a target house to be sold/bought, and other similar houses. Reliability and accuracy of the data provided in the screens may improve over time, as the system is tuned through numerous interactions with real estate agents.

The 1^{st} Screen described elsewhere herein may be useful to facilitate EP computation, e.g. with human involvement. All similar houses (candidates by some a priori baseline or based on any other suitable similarity metric, such as but not limited to similarity estimates described herein) may be marked on a map which is presented to the agent who selects some of them. The agent's selection process may be used to fine-tune the similarity and submarket designations, e.g. to facilitate EP computation. The agent may be presented with a list (or table) of features and a suggested price difference factor for each (e.g., extra bathroom, pool existence, etc.). The agent may emphasize/de-emphasize these factors and may be eventually used for future estimations e.g.to facilitate EP computation or to quantify the difference between similar homes: since homes are not identical clones, the system may correct the price estimation by the difference between a first home which may require a price estimation, and a second home whose known value (e.g. if the second home was sold for a known amount) is used to generate the first home's price estimation. For example, the first home may have an extra room and/or extra bathroom relative to the second home.

The 2^{nd} Screen described elsewhere herein may be used to facilitate the correction of the comparison process and/or to facilitate EP computation, and off-the-shelf tools like restb.ai may be used. Different images of the room may be presented in different tabs, sorted by, say, room type. Specific features may be highlighted on the image itself for assisting the agent to retrieve information deemed important. For example, the system may highlight features deemed important (e.g. affecting prices), that, absent highlighting, might be overlooked or hard for a human looking briefly at dozens of images to find. For example, such features may include a fireplace, or a scratch on a kitchen cupboard.

Alternatively or in addition, relevant agent remarks (for the specific rooms) using NER (e.g. Named Entity Recognition, or functionality configured to classify named entities mentioned in unstructured text, into pre-defined categories) may be sorted and formatted for easier agent report construction. The NER typically facilitates sorting the relevant sentences per room type. If the agent finds certain sentences relevant s/he may mark them, and, at the end the program, may generate “semi automatically” a brief summary of the asset as needed in the comps report.

Referring now to, inter alia, the 3^{rd} Screen described elsewhere herein, the price estimation interval is the final outcome of the comparison report, and may be used to facilitate EP computation. The screen may include supplemented data from other price estimation websites for comparative analysis. The interval may comprise the range of prices from a low similar house (e.g. lowest priced similar house) to the high price similar house after the difference correction.

According to certain embodiments, human agents who are end-users of the platform and/or automated processes may be provided e.g. via importation or suitable API's, with access to MLS data or data (“enriched”) data derived therefrom.

Generally, a multiple listing service (MLS, also multiple listing system or multiple listings service) includes a suite of services that real estate brokers use to establish contractual offers of compensation (among brokers) and accumulate and disseminate information to enable appraisals. Typically, MLS includes basic data such as: price, location, house type, # bedroom # bathroom etc. Enrichment of this basic data may be performed using known tools such as all or any subset of the software tools appearing in the table of FIGS. 9a-9b.

To facilitate EP computation, the system may use all or any subset of the following data from the surroundings (e.g. utilizing Google maps):
Distance to hot spots or a “walk score” to, say, coffee places, entertainment, shopping, restaurants, schools, grocery, library, and parks, accessibility to the nearest metro and railway stations, the distance to the nearest airport, and the number of bus stops in the neighborhood.
Urban fabric—the type of land and ratio of designations (types) as urban, commercial and green areas.
Cultural capital and heavy industries near the assets (house) such as:
   Schools, Universities
   Hi Tech companies
   Film and TV companies
   Performing arts
   Libraries and Museums
Security perception—Crime, health, fires
Environmental data such as air quality, noise levels, landscape (view)
House condition (also renovation level) which may dramatically influence the final price (10% typical). This is the reason why proper analysis thereof is crucial.

The system may use (e.g. to facilitate EP computation) NLP on agent remarks (which is considered as free text) to infer features about the house including its condition and/or renovation level. The system may apply TFIDF (an example NLP tool) e.g. on e.g. on natural language agent remarks, to estimate the house renovation level of the kitchen which improves the price prediction ability of the system.

Additionally, the system may, e.g. to facilitate EP computation, employ image recognition on the listing images to infer the features about the house. For example, Restb.ai may be used; the system may infer, from images, the house condition, room type (e.g., bathroom/kitchen) and also house type (e.g., Mediterranean). This may be used for estimating house condition and/or for generating similarity scores.

According to certain embodiments, an operation is provided which uses restb.ai-generated house features, to compute house condition. Alternatively or in addition, an operation is provided which uses restb.ai-generated house features, to compute similarity. Alternatively or in addition, an operation is provided which gets “house condition” and/or “similarity” as an input, and uses these input/s to compute a house price.

Enrichment for EP may use all or any subset of the software tools presented in the table of FIGS. 9a-9b.

Many variations are possible, e.g. by augmenting any operation described herein or flow including plural operations herein, with conventional teachings such as but not limited to any of the publications mentioned in the Background section e.g. computing neighborhood value estimates using “The economic value of neighborhoods”, using text analysis to augment home price estimation, using “Estimation of the investability of Real Estate Properties Through Text Analysis” and estimating home values using “Vision-based_Real_Estate_Price_Estimation”.

To get accurate EP and EP′ the system may evaluate similarity by collecting data from the agent making the comps (e.g. using the GUI/UX described elsewhere herein).

According to certain embodiments, a (e.g. another) similarity indication may be deduced by the visits potential buyers actually make (to houses which are being sold).

Typically, a list of visits (of the same buyer) already manifests the similarity characteristics from a potential buyer perspective. This list may be “reverse engineered” to determine features which for potential buyers were important or indicative of similarity. For example, properties seen by each given potential buyer in the system, may be considered a cluster, and cluster analysis may be performed. Or, a classifier may be used to select homes “similar to” a given target home (e.g. for a given new potential buyer and/or for a given set of home parameters). To do this, the classifier may be trained using labelled sets of homes which were and were not visited by (were or were not similar to) what certain potential buyers were seeking. This may be used for PC computation.

Another method, e.g. for EP computation, may be configured to designate N house features (translated into vector of N variables) and optionally give weight to their importance in parallel. After vectorizing each house, the system may then compute and figure out the different clusters. For example, several houses may be close in vicinity in a N dimensional space, forming a cluster, hence indicating that by some criteria, the houses within the same cluster are similar.

These methods and others may also use old (or previous) comps reports as training data e.g. for EP computation, for a neural network to classify similar houses.

List price estimation typically comprises plural operations, each of which may be implemented as an aggregate of plural modules. The plural modules may be modified, added, or even deleted, for improving the overall system prediction accuracy and optimization capability. For example (e.g. in FIG. 2a), the first function or operation may be the Estimated Price (EP), which may include plural EP(i) modules, where each module receives components and outputs a score, and all the scores may contribute to the final optimized listing price. EP module examples, all or any subset of which may be provided or may be activated, are:

EP(1): House features (as number of bathrooms, house size, parking spots)

EP(2): Average Prices of similar homes, etc.

EP (3) comps done by a human agent

This operation may comprise price prediction which utilizes algorithms and methods such as neural networks, linear regression, and regression trees.

The second function (e.g. in FIG. 2b) may be EP′ and may include plural EP′(i) modules. EP′ examples, all or any subset of which may be provided, may include:

EP′(1): correction to the comp done by an agent e.g. a human who may visit the site

EP′(2): House condition (from images)

EP′(3): Agent remarks (free text)

EP′(2) and (3) may be performed or generated in software.

Typically, the list price is the final sum of EP′+PC, where PC comprises PC(i) modules (e.g. as shown in FIG. 2c) which facilitate computation of PC, such as all or any subset of:
a. PC(1): seller/buyer status (e.g. need the money fast, have children, etc.)

b. PC(1): seller/buyer status agent intuitions

c. PC(2): market status (many/few similar houses available)

d. PC(2): market status human estimate

e. PC(3): bidding environment and culture of the sub market (e.g., under or over listing price compared to the estimated house price). Metrics which represent this may be the number of bidders, days on the market of the asset, etc.

Any suitable implementation or architecture may be employed, to facilitate utilization of plural modules per stage e.g. generating estimated price (EP), using, at various points within the lifetime of the platform or system, all or a changing subset of plural EP(i) modules, and/or generating EP′ using, at various points within the lifetime of the platform or system, all or a changing subset of plural EP′(i) modules and/or generating PC values, using, at various points within the lifetime of the platform or system, all or a changing subset of plural PC(i) modules

All or any subset of the following may for example be provided:
1. A list of modules. Each item on the list includes, inter alia, all or any subset of: a name and a calling procedure, active state (e.g. module to be used or not used) and weight (e.g., a real number between 0 to 1).
2. A combining method which may comprise a function, used by a hardware processor to weight the output results of each module and generate a combined output result. For example, this can be a weighted average. Continuing this example, if there are 3 modules, A, B and C, and only A, C are both active with corresponding weights of 0.3 and 0.1 and corresponding outputs Xa, Xc, then the combined result will be (0.3Xa+0.1Xc)/(0.3+0.1)=0.75Xa+0.25Xb. the combining method can be any function or process which weighs the results (e.g., if (Xa>Xc) and (A's weight is greater than C's weight) then output Xa else output Xc).

Typically, each time an estimate takes place, all active modules are used (run) and their outputs (results) are stored. The combining method is then applied on the results and a combined result is derived. Different combining methods may be used at different points within the lifetime of the platform or system.

Deleting a module may include changing its active state to ‘not used’ and/or deleting the software component completely from the list of modules. Adding a module may include adding the module's particulars to the list. Updating a module may include deleting the module's previous version from the list, and adding the new version of the module to the list. A deletion or addition or modification may require updating the combining method e.g. when a more comprehensive combination of results is implemented. A platform may for example, early in its lifetime, start with one or two modules and increase the number of modules as new training data becomes available and/or as new data sources become accessible.

For example, data from an external source which wasn't available early in the platform's life cycle, may later become available e.g. as part of a new subscription to a data service or due to maturity (e.g., data collection finalized during the platform's life cycle).

Also, Data enrichment—the need for certain data becomes apparent only later in the platform's life cycle, but not initially. For example, new research may correlate house pricing with presence of certain brand stores or transportation services at nearby locations. This data may be added and used at a later stage and may either create an additional module or update an existing one.

Also, Feedback data may become available increasingly, during the platform's lifetime. For example, as real estate transactions take place and outcomes thereof including selling price and identity of buyer are recorded by the system, the actual and current selling prices may be compared to the listed prices and insights derived therefrom may be used to augment other processes or modules e.g. more/less successful pricing strategies depending on various success criteria such as high selling price relative to estimated value and/or rapid sale vs. long time on the market.

It is appreciated that the methods for determining similarity described herein are merely intended to be exemplary of possible methods e.g. any of those referred to here: en.wikipedia.org/wiki/Similarity_measure. Also, these methods may be used standalone or in other use cases, rather than necessarily for the specific use-cases and/or context specifically described herein.

The system may derive a score of similarity between houses in a system database and may then use the prices of similar, already sold houses, as a first estimation for the EP of a target house whose price is unknown.

Referring again to EP computation, it is appreciated that determining a “similar” house may be useful in estimating another house price (in partial reliance on the known value of the first house). All the data discussed above (e.g. MLS) may contribute to an evaluation of a similarity score. Similarity is typically a function of the specific submarket which may, for example, be defined as the area around the house bounded by highway roads.

It is appreciated that any suitable formula or process may be used for determining which houses are “similar”. Even a simple model comparing price and number of rooms may be used.

Conventionally, price estimation may be done by agents making a comps report—“Comps or “Comparables” report is a tool highly valued by Real Estate investors. ‘Running’ comps is a term used when trying to find properties with similar characteristics to a subject or target property based on, say, all or any subset of: location, square feet, bedrooms, bathrooms, etc. to help determine the value of a subject property.

In all functional operations and modules, the scores or values (e.g. EP, EP′, PC inter alia) generated by functions and methods described herein, may be a suitable, logical and/or computational, simple or weighted combination of different components, generated by functions and methods described herein, to suitably balance all the features, e.g. depending on the use-case and/or as learned over time (if the system has machine learning capability). For this, techniques as simple linear regression, decision trees or deep neural network may be employed. The methods of choice or the choice of combination, may be a tradeoff between prediction accuracy and system performance. For example, a process which yields highly accurate values, but requires a great deal of memory and/or CPU time, may be performed less frequently (e.g. only for certain tasks e.g. only for high-value properties) than a process which is just as accurate, but requires less memory and/or CPU time.

It is appreciated that terminology such as “mandatory”, “required”, “need” and “must” refer to implementation choices made within the context of a particular implementation or application described herewithin for clarity and are not intended to be limiting, since, in an alternative implementation, the same elements might be defined as not mandatory and not required, or might even be eliminated altogether.

Components described herein as software may, alternatively, be implemented wholly or partly in hardware and/or firmware, if desired, using conventional techniques, and vice-versa. Each module or component or processor may be centralized in a single physical location or physical device or distributed over several physical locations or physical devices.

Included in the scope of the present disclosure, inter alia, are electromagnetic signals in accordance with the description herein. These may carry computer-readable instructions for performing any or all of the operations of any of the methods shown and described herein, in any suitable order including simultaneous performance of suitable groups of operations, as appropriate. Included in the scope of the present disclosure, inter alia, are machine-readable instructions for performing any or all of the operations of any of the methods shown and described herein, in any suitable order, program storage devices readable by machine, tangibly embodying a program of instructions executable by the machine to perform any or all of the operations of any of the methods shown and described herein, in any suitable order i.e. not necessarily as shown, including performing various operations in parallel or concurrently rather than sequentially as shown; a computer program product comprising a computer useable medium having computer readable program code, such as executable code, having embodied therein, and/or including computer readable program code for performing, any or all of the operations of any of the methods shown and described herein, in any suitable order; any technical effects brought about by any or all of the operations of any of the methods shown and described herein, when performed in any suitable order; any suitable apparatus or device or combination of such, programmed to perform, alone or in combination, any or all of the operations of any of the methods shown and described herein, in any suitable order; electronic devices each including at least one processor and/or cooperating input device and/or output device and operative to perform, e.g. in software, any operations shown and described herein; information storage devices or physical records, such as disks or hard drives, causing at least one computer or other device to be configured so as to carry out any or all of the operations of any of the methods shown and described herein, in any suitable order; at least one program pre-stored e.g. in memory or on an information network such as the Internet, before or after being downloaded, which embodies any or all of the operations of any of the methods shown and described herein, in any suitable order, and the method of uploading or downloading such, and a system including server/s and/or client/s for using such; at least one processor configured to perform any combination of the described operations or to execute any combination of the described modules; and hardware which performs any or all of the operations of any of the methods shown and described herein, in any suitable order, either alone or in conjunction with software. Any computer-readable or machine-readable media described herein is intended to include non-transitory computer- or machine-readable media.

Any computations or other forms of analysis described herein may be performed by a suitable computerized method. Any operation or functionality described herein may be wholly or partially computer-implemented e.g. by one or more processors. The invention shown and described herein may include (a) using a computerized method to identify a solution to any of the problems or for any of the objectives described herein, the solution optionally includes at least one of a decision, an action, a product, a service or any other information described herein that impacts, in a positive manner, a problem or objectives described herein; and (b) outputting the solution.

The system may, if desired, be implemented as a web-based system employing software, computers, routers and telecommunications equipment as appropriate.

Any suitable deployment may be employed to provide functionalities e.g. software functionalities shown and described herein. For example, a server may store certain applications, for download to clients, which are executed at the client side, the server side serving only as a storehouse. Any or all functionalities e.g. software functionalities shown and described herein may be deployed in a cloud environment. Clients e.g. mobile communication devices, such as smartphones, may be operatively associated with, but external to, the cloud.

The scope of the present invention is not limited to structures and functions specifically described herein and is also intended to include devices which have the capacity to yield a structure, or perform a function, described herein, such that even though users of the device may not use the capacity, they are, if they so desire, able to modify the device to obtain the structure or function.

Any “if-then” logic described herein is intended to include embodiments in which a processor is programmed to repeatedly determine whether condition x, which is sometimes true and sometimes false, is currently true or false, and to perform y each time x is determined to be true, thereby to yield a processor which performs y at least once, typically on an “if and only if” basis e.g. triggered only by determinations that x is true and never by determinations that x is false.

Any determination of a state or condition described herein, and/or other data generated herein, may be harnessed for any suitable technical effect. For example, the determination may be transmitted or fed to any suitable hardware, firmware or software module, which is known or which is described herein to have capabilities to perform a technical operation responsive to the state or condition. The technical operation may for example comprise changing the state or condition, or may more generally cause any outcome which is technically advantageous given the state or condition or data, and/or may prevent at least one outcome which is disadvantageous given the state or condition or data. Alternatively or in addition, an alert may be provided to an appropriate human operator or to an appropriate external system.

Features of the present invention, including operations, which are described in the context of separate embodiments, may also be provided in combination in a single embodiment. For example, a system embodiment is intended to include a corresponding process embodiment, and vice versa. Also, each system embodiment is intended to include a server-centered “view” or client centered “view”, or “view” from any other node of the system, of the entire functionality of the system, computer-readable medium, apparatus, including only those functionalities performed at that server or client or node. Features may also be combined with features known in the art and particularly, although not limited to, those described in the Background section or in publications mentioned therein.

Conversely, features of the invention, including operations, which are described for brevity in the context of a single embodiment, or in a certain order, may be provided separately or in any suitable subcombination, including with features known in the art (particularly although not limited to those described in the Background section or in publications mentioned therein) or in a different order. “e.g.” is used herein in the sense of a specific example which is not intended to be limiting. Each method may comprise all or any subset of the operations illustrated or described, suitably ordered e.g. as illustrated or described herein.

Devices, apparatus or systems shown coupled in any of the drawings may in fact be integrated into a single platform in certain embodiments, or may be coupled via any appropriate wired or wireless coupling, such as but not limited to optical fiber, Ethernet, Wireless LAN, HomePNA, power line communication, cell phone, Smart Phone (e.g. iPhone), Tablet, Laptop, PDA, Blackberry GPRS, Satellite including GPS, or other mobile deliver. It is appreciated that in the description and drawings shown and described herein, functionalities described or illustrated as systems and sub-units thereof can also be provided as methods and operations therewithin, and functionalities described or illustrated as methods and operations therewithin can also be provided as systems and sub-units thereof. The scale used to illustrate various elements in the drawings is merely exemplary and/or appropriate for clarity of presentation and is not intended to be limiting.

Any suitable communication may be employed between separate units herein e.g. wired data communication and/or in short-range radio communication with sensors such as cameras e.g. via WiFi, Bluetooth or Zigbee.

It is appreciated that implementation via a cellular app as described herein is but an example, and, instead, embodiments of the present invention may be implemented, say, as a smartphone SDK; as a hardware component; as an STK application, or as suitable combinations of any of the above.

Any processing functionality illustrated (or described herein) may be executed by any device having a processor, such as but not limited to a mobile telephone, set-top-box, TV, remote desktop computer, game console, tablet, mobile e.g. Laptop or other computer terminal, embedded remote unit, which may either be networked itself (may itself be a node in a conventional communication network e.g.) or may be conventionally tethered to a networked device (to a device which is a node in a conventional communication network or is tethered directly or indirectly/ultimately to such a node).

1. A computerized system for estimating real estate value, the system comprising:
a user interface prompting human experts to generate at least one first estimate of at least one real estate item's value; and
a processor configured to receive input characterizing said at least one real estate item aka asset (e.g. house), and, based at least partly on said input, to generate at least one second estimate of the at least one real estate item's value; and
logic which combines said at least one first estimate and said at least one second estimate, thereby to yield an ensemble estimate of the at least one real estate item's value.

2. A system according to claim 1 wherein an NN based similar listing finder is used which is configured to identify a similar listing to at least one real estate item using user-item engagement (“collaborative”) data for houses features and embedding plural house features into an N-dimensional space, the method including training a deep neural network according to houses previously chosen by end-users.

3. A system according to claim 1 wherein convolutional NN is used to analyze house images including identification of the level of renovation of at least one room in said real estate item.

4. A system according to claim 1 wherein said input includes house-style of said at least one real estate item (e.g. house) as derived from automatic analysis of digital house images.

5. A system according to claim 1 wherein said input includes at least one real estate item feature derived from at least one of street view and satellite images of said at least one real estate item.

6. A system according to claim 5 wherein said feature is derived from an AI process receiving at least one of said street view and said satellite images.

7. A system according to claim 6 wherein said AI process comprises convolutional NN.

8. A system according to claim 5 wherein said feature includes at least one of: view, house positioning, house layout.

9. A system according to claim 1 wherein said input includes name entity recognition (NER) data derived or mined from text describing the asset which is read by the system.

10. A system according to claim 9 wherein said name entity recognition (NER) data is derived by bidirectional LSTMs.

11. A system according to claim 1 wherein at least one deep learning and/or neural network library, e.g. Keras, is used to implement at least one operation.

12. A system according to claim 10 wherein Bidirectional LSTMs are provided using Keras's bidirectional layer wrapper.

13. A system according to claim 1 wherein said processor generates said second estimate based also on heuristics which use pricing strategy data.

14. A system according to claim 13 wherein said pricing strategy data includes a numerical level ranking urgency to sell said asset.

15. A system according to claim 13 wherein said pricing strategy data includes an indication of high/low MOI.

16. A system according to claim 13 wherein said heuristics include market-culture-data-dependent decisions re whether to overprice or underprice.

17. A system according to claim 16 wherein said market-culture-data is estimated for each submarket using an SP/LP ratio plot, and wherein a ratio larger than one means an underpricing strategy, while a ratio smaller than one means an overpricing strategy.

18. A system according to claim 1 wherein said logic is configured to combine said at least one first estimate and said at least one second estimate.

19. A system according to claim 1 wherein a human agent provides at least one input toward value estimation of at least one real estate property, to the system, after having first been presented with at least partly computer-generated data characterizing the real estate property, and wherein said input provided to the system by the agent after having first been presented with said data, is subsequently used at least once by the system for estimation of value of the real estate property.

20. A system comprising at least one hardware processor configured to carry out the operations of the method of claim 1.
